(19) United States
(12) Patent Application Publication
(10) Pub. No.: US 2026/0098609 A1
(43) Pub. Date: Apr. 9, 2026

(54) PRESSURE VESSEL

(71) Applicant: Toyota Jidosha Kabushiki Kaisha, Toyota-shi (JP)

(72) Inventors: Osamu SAWAI, Okazaki-shi (JP); Yuki Kai, Nagoya-shi (JP)

(73) Assignee: TOYOTA JIDOSHA KABUSHIKI KAISHA, Toyota-shi (JP)

(21) Appl. No.: 19/336,775

(22) Filed: Sep. 23, 2025

(30) Foreign Application Priority Data
Oct. 8, 2024 (JP) 2024-176686

(51) Int. Cl. F17C 1/06

(52) U.S. Cl. CPC F17C 1/06; F17C 2201/0147; F17C 2203/011; F17C 2203/0673; F17C 2221/012; F17C 2270/0168

(57) ABSTRACT

A pressure vessel in which fluid is storable includes a plurality of main body portions that each forms a space on the inside, and one or more connecting portions that each provide communication between the main body portions. The main body portion and the connecting portion are alternately connected in series and the connecting portion is bent, and a section of the main body portion perpendicular to the longitudinal direction has a substantially quadrilateral shape. The main body portion has a reinforcing member that connects a pair of surfaces facing each other in the space.

### CROSS-REFERENCE TO RELATED APPLICATION

This application claims priority to Japanese Patent Application No. 2024-176686 filed on Oct. 8, 2024. The disclosure of the above-identified application, including the specification, drawings, and claims, is incorporated by reference herein in its entirety.

### BACKGROUND

### 1. Technical Field

The technology disclosed in the present specification relates to a pressure vessel.

### 2. Description of Related Art

In Japanese Unexamined Patent Application Publication (Translation of PCT Application) No. 2018-519480 (JP 2018-519480 A), a pressure vessel for storing therein fluid is disclosed. The pressure vessel in JP 2018-519480 A alternately has cylindrical tubes serving as liner cavities and flexible connectors, and the pressure vessel can be folded into a housing as a result of bending parts of the flexible connectors.

### SUMMARY

Hitherto, a pressure vessel has had a cylindrical shape, and hence it has been difficult to say that a capacity for storing fluid therein is efficiently secured.

The present specification discloses a pressure vessel in which fluid is storable. The pressure vessel includes a plurality of main body portions that each forms a space inside, and one or more connecting portions that each provide communication between the main body portions. In the pressure vessel, the main body portion and the connecting portion are alternately connected in series and the connecting portion is bent, and a section of the main body portion perpendicular to the longitudinal direction has a substantially quadrilateral shape.

With the configuration, the section of the main body portion of the pressure vessel that is a section perpendicular to the longitudinal direction has a substantially quadrilateral shape. Therefore, it is possible to secure a greater capacity as compared to the related art in which such a section has a circular shape.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a pressure vessel;

FIG. 2 is a sectional view taken along line II-II in FIG. 1;

FIG. 3 is a sectional view taken along line III-III in FIG. 1;

FIG. 4 is a sectional view showing the vicinity of one end of a main body portion to which a cap is attached in an enlarged manner;

FIG. 5 is a view showing a pressure vessel according to a modified example accommodated in an underfloor space of a vehicle; and

FIG. 6 is a view showing a related-art pressure vessel accommodated in an underfloor space of a vehicle.

### DETAILED DESCRIPTION OF EMBODIMENTS

An embodiment of the present disclosure is described with reference to the drawings. Each drawing is merely an exemplification, and the present embodiment is not limited to the illustrated content. Each drawing is an exemplification, and hence a part thereof may be omitted.

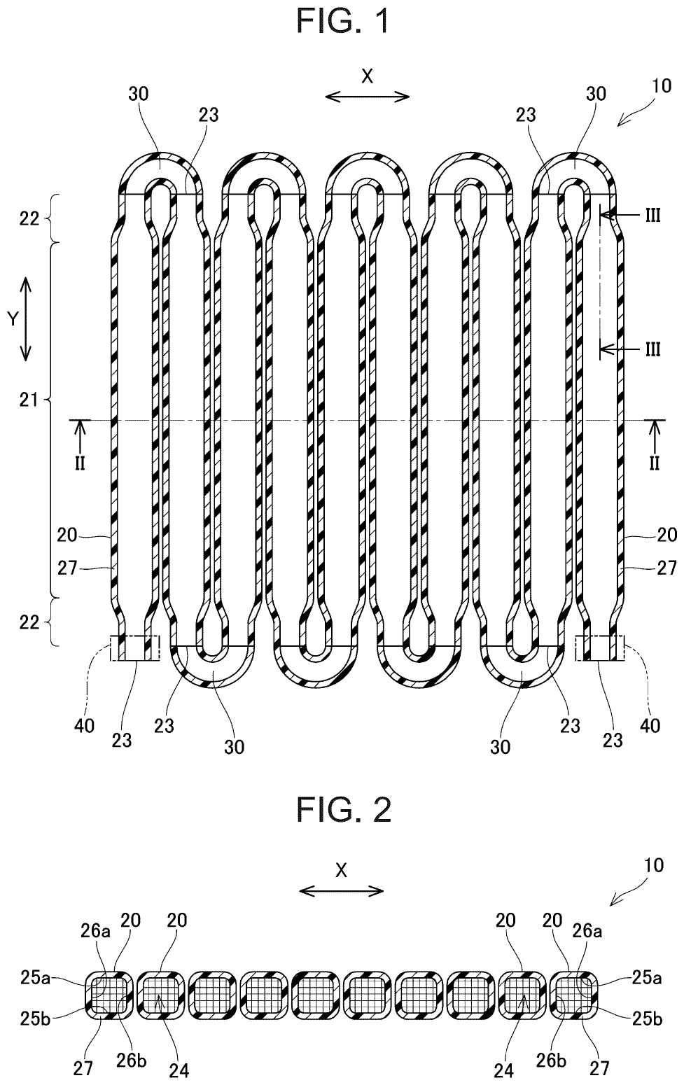

In FIG. 1, a pressure vessel 10 according to the present embodiment is shown in a simplified manner by a sectional view. The pressure vessel 10 can store therein fluid. The fluid is fuel gas such as hydrogen, for example. In each diagram, the X-direction and the Y-direction are indicated, as appropriate, for the ease of explanation. The X-direction and the Y-direction are orthogonal to each other. The pressure vessel 10 includes a plurality of main body portions 20 forming a space on its inside, and one or more connecting portions 30 that provide communication between the main body portions 20. Each connecting portion 30 provides communication between the main body portions 20, and hence a space is naturally formed on its inside.

According to FIG. 1, the main body portion 20 is long in the Y-direction, and both ends in the Y-direction thereof are openings 23. According to FIG. 1, the Y-direction corresponds to the longitudinal direction of the main body portion 20. The main body portion 20 includes a body portion 21 in which the shape of the section perpendicular to the longitudinal direction is substantially definite, and tapered portions 22 serving as both end portions for the body portion 21 in the longitudinal direction thereof. In each tapered portion 22, a sectional area perpendicular to the longitudinal direction becomes narrower from the body portion 21 to the opening 23 in a gradual or a stepwise manner. The section of the main body portion 20 that is a section perpendicular to the longitudinal direction is hereinafter called a “first section”.

According to FIG. 1, the main body portions 20 are arranged side by side along the X-direction (one direction). The main body portions 20 are disposed in substantially the same positions in the Y-direction. When the entire pressure vessel 10 is seen, the main body portions 20 and the connecting portions 30 are alternately connected in series. The connecting portion 30 is bent between the opening 23 of one main body portion 20 and the opening 23 of another main body portion 20. According to FIG. 1, the connecting portion 30 provides communication between the main body portions 20 adjacent to each other in the X-direction by being curved by 180 degrees in a substantially U-like shape. In the pressure vessel 10 as above, communication is provided from the main body portion 20 positioned on one end to the main body portion 20 positioned on the other end in the X-direction in a single line.

FIG. 2 is a sectional view taken along line II-II in FIG. 1. FIG. 2 shows the shape of the first section of the main body portion 20. As shown in FIG. 2, the first section has a substantially quadrilateral shape. The substantially quadrilateral shape means a shape having two pairs of planar surfaces facing each other (a pair of surfaces 25a, 25b and a pair of surfaces 26a, 26b) and four angles that connect those four surfaces. It is closer to reality to say that the four angles of the first section are curved in a curved shape than to say that the planar surfaces intersect with each other at a right angle. The planar surfaces facing each other and forming the first section do not necessarily need to be exactly in parallel to each other, and each planar surface may be slightly bowed.

The connecting portion 30 is a pipe that connects the opening 23 of one main body portion 20 and the opening 23 of another main body portion 20 to each other, and hence a section perpendicular to the flow path direction thereof is basically narrower than the first section of the body portion 21. However, in the present embodiment, it is not essential for the section of the connecting portion 30 to be narrower than the first section of the body portion 21. In other words, it is possible for the main body portion 20 to not include the tapered portion 22, and both ends of the body portion 21 may be the openings 23. In this case, the body portion 21 and the connecting portion 30 are directly connected to each other.

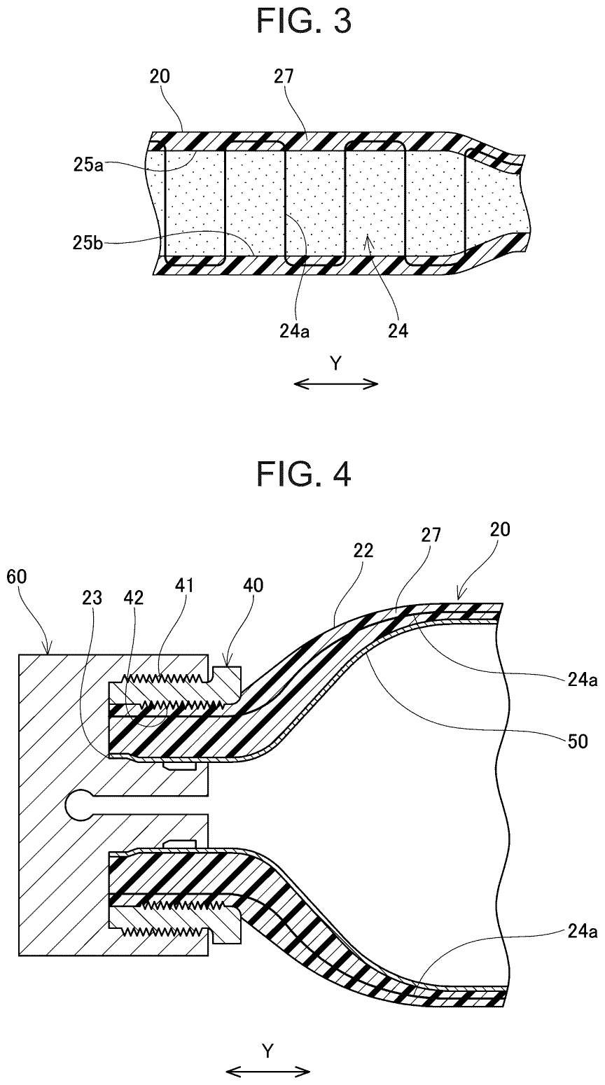

FIG. 3 is a sectional view taken along line III-III in FIG. 1. The main body portion 20 has a reinforcing member 24 that connects a pair of surfaces that faces each other in the space of the main body portion 20. In FIG. 3, a wire rod 24a that connects a pair of the surface 25a and the surface 25b of the main body portion 20 that faces each other in a wave-like form is shown. The wire rod 24a is formed by carbon fiber reinforced plastics (CFRP) that are a composite material of carbon fiber and resin. In other words, the reinforcing member 24 includes one or more wire rods 24a that extend in the longitudinal direction of the main body portion 20 while sewing up a place between the pair of surfaces.

In FIG. 3, a plurality of black dots in the main body portion 20 each indicates a section of the wire rod 24a. In FIG. 2, a plurality of lines drawn in the main body portion 20 in a grid-like manner each also indicates the wire rod 24a. In other words, in the space of the main body portion 20, each place between the pair of surfaces 25a, 25b, and each place between another pair of surfaces 26a, 26b facing each other, is sewn up by the wire rods 24a. The reinforcing member 24 includes the wire rods 24a as above. In FIG. 1, the reinforcing members 24 are omitted.

One example of a method of manufacturing the pressure vessel 10 is briefly described. The pressure vessel 10 in a state before the connecting portions 30 are bent is hereinafter called the pressure vessel 10 before bending. First, a liner serving as a hollow body that becomes a base material of the pressure vessel 10 before bending is prepared. The liner is formed by resin such as nylon, for example. The liner is a hollow body in which main-body-shaped portions each having a shape equivalent to the main body portion 20 and connecting-shape portions each having a shape equivalent to the connecting portion 30 before bending are integrally molded in an alternating and linear manner. A wire rod is wound around an outer surface of the liner as above in a net-like manner or a spiral manner, for example, by a winding machine. The winding machine is also called a braiding machine, a braider, or the like. The wire rod wound around the liner is also CFRP in which carbon fiber is impregnated with resin. By the winding of the wire rod by the winding machine, a fiber layer 27 obtained by CFRP is formed so as to cover the outer surface of the liner.

At the same time as the winding of the wire rod by the winding machine, the sewing of the liner with the wire rod 24a by a sewing machine is executed. Various sewing methods such as a running stitch and a so-called sewing-machine stitch in which an upper thread (wire rod 24a) and a lower thread (wire rod 24a) are tied together are used as the sewing method of the wire rod 24a by the sewing machine. By the sewing of the wire rod 24a by the sewing machine, the wire rod 24a passes through the space inside the liner, and the reinforcing member 24 as shown in FIG. 3 is provided, for example.

The liner, the winding machine, and the sewing machine are relatively moved along the longitudinal direction of the liner. For example, the positions of the winding machine and the sewing machine are fixed, and the liner is moved along the longitudinal direction thereof with respect to the winding machine and the sewing machine. In accordance with this movement, the sewing with the wire rod 24a by the sewing machine and the winding of the wire rod by the winding machine are concurrently performed. As a result, the pressure vessel 10 before bending can be efficiently manufactured while the part of the wire rod 24a other than the part that passes through the space of the main body portion 20 is fitted in the layer of the fiber layer 27 as shown in FIG. 3. The pressure vessel 10 before bending manufactured as above then becomes the pressure vessel 10 having the shape as shown in FIG. 1 as a result of each connecting portion 30 being bent in a substantially U-like shape.

As above, according to the present embodiment, in the pressure vessel 10, the first section has a substantially quadrilateral shape. Therefore, it is possible to secure a greater capacity for storing the fluid as compared to a related-art configuration in which the section perpendicular to the longitudinal direction of the pressure vessel has a circular shape.

In terms of securing strength against the pressure of the fluid, it can be said that the related-art section that has a circular shape is better than the first section that has a substantially quadrilateral shape. However, in the present embodiment, the main body portion 20 has a configuration of having the reinforcing member 24 that connects surfaces facing each other. As a result, in the main body portion 20, the strength against the pressure of the fluid can be secured while the first section has a substantially quadrilateral shape.

The entire pressure vessel 10 before bending is manufactured while an integrally molded liner is used as a base material and the winding and the sewing described above are concurrently performed. As a result, as compared to the related art in which the pressure vessel is manufactured by connecting a plurality of parts having different thickness and shapes, the number of parts and the workload are reduced, and the pressure vessel 10 can be manufactured at low cost.

Regarding the connecting portion 30, various shapes may be employed for the section perpendicular to the flow path direction thereof. The section of the connecting portion 30 perpendicular to the flow path direction may have a substantially quadrilateral shape as with the main body portion 20 or may have any of a circular shape and an elliptical shape. The elliptical shape is basically a shape including a pair of straight lines that is substantially in parallel with each other and a pair of arcs that connects those straight lines to each other but may include an oval in a broad sense. The connecting portion 30 may have a so-called bellows structure in which a mountain fold and a valley fold are repeated regardless of the sectional shape thereof. It becomes easy to bend the connecting portion 30 by causing the connecting portion 30 to have a bellows structure.

In the pressure vessel 10, a cap 40 is provided on one end of the main body portion 20 positioned on one end of the series connection out of the main body portions 20. In FIG. 1, as indicated by two-dot chain lines, the cap 40 is attached to one end of each of the main body portions 20 positioned on one end and the main body portion 20 positioned on the other end in the X-direction.

FIG. 4 shows the vicinity of one end of the main body portion 20 to which the cap 40 is attached by an enlarged sectional view. According to FIG. 4, the main body portion 20 has the liner 50 serving as an inner layer and the fiber layer 27 serving as an outer layer. The liner 50 is not illustrated in drawings other than FIG. 4 due to simplification. In one end of the main body portion 20, for example, a predetermined range close to the opening 23 of the tapered portion 22 (a range in the vicinity of the opening) is a pipe having a diameter that is substantially the same as that of the opening 23, and the cap 40 is attached to the range in the vicinity of the opening from the outer side. For example, the cap 40 is made of metal, and is formed in an annular shape.

A thread groove 41 for screwing a fastening portion 60 described later is formed in an outer peripheral surface of the cap 40. Meanwhile, a plurality of locking claws 42 is formed on an inner peripheral surface of the cap 40. When the cap 40 is crimped with respect to the range in the vicinity of the opening of the main body portion 20, the locking claws 42 bite into an outer peripheral surface of the fiber layer 27. As a result, the cap 40 is locked to the main body portion 20.

The fastening portion 60 is fastened to the cap 40 from the outer side. In other words, a female thread portion formed in the fastening portion 60 on its inner side and the thread groove 41 of the cap 40 are screwed together. As a result, the fastening portion 60 is fastened to the cap 40. In the example of FIG. 4, a part of the fastening portion 60 enters the inner side of the opening 23 and seals the opening 23. The fastening portion 60 may have a structure in which the opening 23 communicates with a flow path (not shown) outside of the pressure vessel 10.

As described above, the reinforcing member 24 includes the wire rod 24a that extends in the longitudinal direction of the main body portion 20 while sewing up a place between the surfaces of the main body portion 20 facing each other. Thus, in the present embodiment, on one end of the main body portion 20 on which the cap 40 is provided, one end of the wire rod 24a may be fixed to a position far from the cap 40. In FIG. 4, the wire rods 24a are indicated by solid lines in the fiber layer 27. The ends of the wire rods 24a are embedded in the layers of the fiber layers 27 and in a position that the locking claws 42 of the cap 40 do not reach. In other words, as described above, when the sewing with the wire rod 24a by the sewing machine and the winding of the wire rod by the winding machine are concurrently executed, one end of each wire rod 24a is embedded in a predetermined position that the locking claws 42 do not reach in the fiber layer 27 in one end of the main body portion 20 to which the cap 40 is attached later. The end portion treatment of the wire rods 24a as above is performed on one end of each of the main body portions 20 positioned on one end and the main body portion 20 positioned on the other end in the X-direction shown in FIG. 1. With the configuration described above, a case in which the locking claws 42 come into contact with the wire rod 24a in the fiber layer 27 is avoided. Therefore, the biting of the locking claws 42 into the fiber layer 27 is not inhibited, and the cap 40 is firmly locked to the main body portion 20.

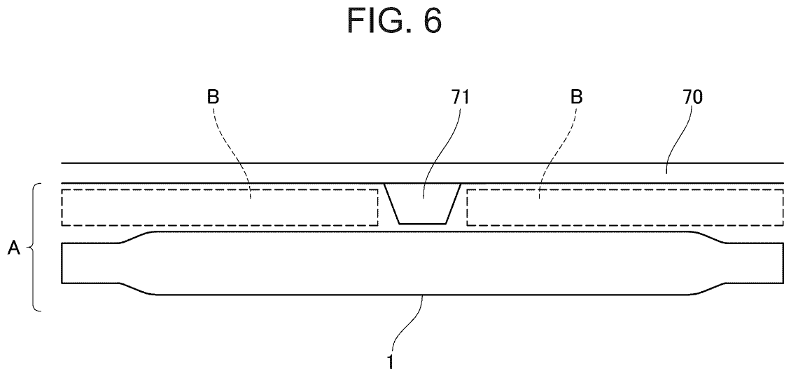

The pressure vessel 10 is accommodated in a space under a floor of the vehicle, for example. The vehicle referred to here is a fuel cell electric vehicle, a hydrogen engine vehicle, or the like that generates electricity and generates motive power with use of hydrogen stored in the pressure vessel 10 as fuel. FIG. 6 shows a related-art pressure vessel 1 accommodated in an underfloor space A of the vehicle. The pressure vessel 1 is a general hydrogen tank having a cylindrical shape in which a section perpendicular to the longitudinal direction has a circular shape. A part of the underfloor space A is defined by a body member 70 that provides partition between a place above the floor and a place under the floor of the vehicle.

The body member 70 has a protruding portion 71 protruding downward in a predetermined position. The body member 70 and the protruding portion 71 correspond to a part of a vehicle body. The protruding portion 71 is a floor crossmember for improving the rigidity of the vehicle body, for example. As shown in FIG. 6, there have hitherto been spaces B that are dead spaces between the body member 70 and the pressure vessel 1 due to the existence of the protruding portion 71. The pressure vessel 1 has been downsized so as to be able to be accommodated in the underfloor space A in a position below the protruding portion 71.

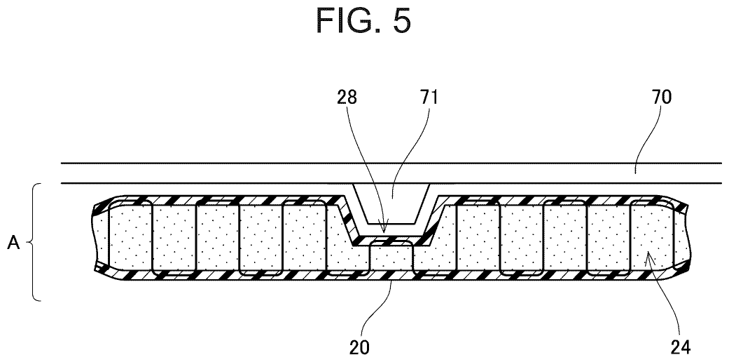

In view of a state as above, as a modified example of the present embodiment, the main body portion 20 may have a depression and protrusion shape along the shape of the vehicle body that defines at least a part of the space in which the pressure vessel 10 is accommodated. FIG. 5 shows the pressure vessel 10 according to the modified example accommodated in the underfloor space A of the vehicle. In FIG. 5, only the main body portion 20 out of the pressure vessel 10 is shown by a section seen from the same point of view as FIG. 3.

According to FIG. 5, a depressed portion 28 for avoiding contact with the protruding portion 71 is formed in a position corresponding to the protruding portion 71 in an upper surface of the main body portion 20, that is, the surface facing the body member 70. The depressed portion 28 is formed in the body portion 21. As it can be understood from the description above, an outer surface of the body portion 21 is a planar surface, and hence it is easier to form the depressed portion 28 as compared to the related-art pressure vessel 1 having a cylindrical shape. The first section of the range in which the depressed portion 28 is formed out of the body portion 21 is naturally narrower than the first section of the range in which the depressed portion 28 is not formed out of the body portion 21.

It can be said that the expression of “the main body portion 20 has the depressed portion 28” means that the main body portion 20 also has protruding portions with reference to the depressed portion 28. Therefore, the shapes of the depressed portion 28 and the periphery thereof correspond to specific examples of a depression and protrusion shape along the shape of the vehicle body. With the example as above, the pressure vessel 10 can be accommodated by also using the spaces B out of the underfloor space A by avoiding contact with the protruding portion 71 by the depressed portion 28. In other words, it becomes possible to upsize the pressure vessel 10 or increase the capacity of the pressure vessel 10 while effectively using the limited underfloor space A of the vehicle. In FIG. 5, only one main body portion 20 is shown, but it may be understood that each of the main body portions 20 arranged in the X-direction has the depressed portion 28 in accordance with the length of the protruding portion 71 in the X-direction.

In the pressure vessel 10 of the present embodiment, the existence of the liner is not essential. The pressure vessel 10 may have a configuration that does not have a liner in at least a form after manufacturing, for example. The pressure vessel 10 may be manufactured by a method that does not use a liner.

Although specific examples of the technology disclosed by the present specification have been described above in detail, those are merely exemplifications and do not limit the scope of the claims. The technology described in the scope of claims includes those obtained by variously modifying and changing the specific examples exemplified above. The technical elements described in the present specification or the drawings exhibit a technical utility by itself or by various combinations, and are not limited to the combinations described in the claims as originally filed. The technology exemplified in the present specification or the drawings achieves a plurality of objects at the same time, and has a technical utility by achievement of one of those objects itself.

What is claimed is:

1. A pressure vessel in which fluid is storable, the pressure vessel comprising:
a plurality of main body portions that each forms a space inside; and
one or more connecting portions that each provide communication between the main body portions, wherein:
the main body portion and the connecting portion are alternately connected in series and the connecting portion is bent; and
a section of the main body portion perpendicular to a longitudinal direction has a substantially quadrilateral shape.

2. The pressure vessel according to claim 1, wherein the main body portion has a reinforcing member that connects a pair of surfaces facing each other in the space.

3. The pressure vessel according to claim 2, wherein:
the reinforcing member includes one or more wire rods extending in the longitudinal direction, the one or more wire rods being provided so as to sew up a place between the pair of surfaces;
a cap is provided on one end of a main body portion positioned on one end of the connection in series out of the main body portions; and
one end of the wire rod is fixed, in the one end of the main body portion on which the cap is provided, to a position far from the cap.

4. The pressure vessel according to claim 1, wherein the main body portion has a depression and protrusion shape along a shape of a vehicle body that defines at least a part of a space in which the pressure vessel is accommodated.

5. The pressure vessel according to claim 1, wherein a section of the connecting portion perpendicular to a flow path direction has any of a circular shape, an elliptical shape, and a substantially quadrilateral shape.
